(19) United States
(12) Patent Application Publication
(10) Pub. No.: US 2005/0056574 A1
(43) Pub. Date: Mar. 17, 2005

(54) Unloading machine

(75) Inventors: Matthias Emanuel, Ober-Morlen (DE); Wilfried Hahn, Weiterstadt (DE)

Correspondence Address: MCDERMOTT WILL & EMERY LLP, 600 13TH STREET, N.W., WASHINGTON, DC, 20005-3096, US

(73) Assignee: BOWE BELL & HOWELL GMBH

(21) Appl. No.: 10/943,204

(22) Filed: Sep. 17, 2004

(30) Foreign Application Priority Data
Sep. 17, 2003 (DE) 10343370.8

(51) Int. Cl. B07C 5/00; G06K 9/00

(52) U.S. Cl. 209/584; 209/900

(57) ABSTRACT

Method for equipping a machine, especially for loading a letter sorting machine, which at the beginning comprises a conveying device for the delivery of singled incoming goods. The incoming goods are flat goods, namely letters 1, which are delivered to an unloading device while heaped in a box 2. The box 2 is seized by the unloading device, emptied and singled out of the processing cycle. The removed heap 1a is levelled by the unloading device into a stack flush on two sides. The stack is delivered to the conveying device, and the emptied stack 1a is seized by a grab 5, which seizes the emptied stack 1a by means of clamping it between two seizing hands 6 and leads it towards further treatment.

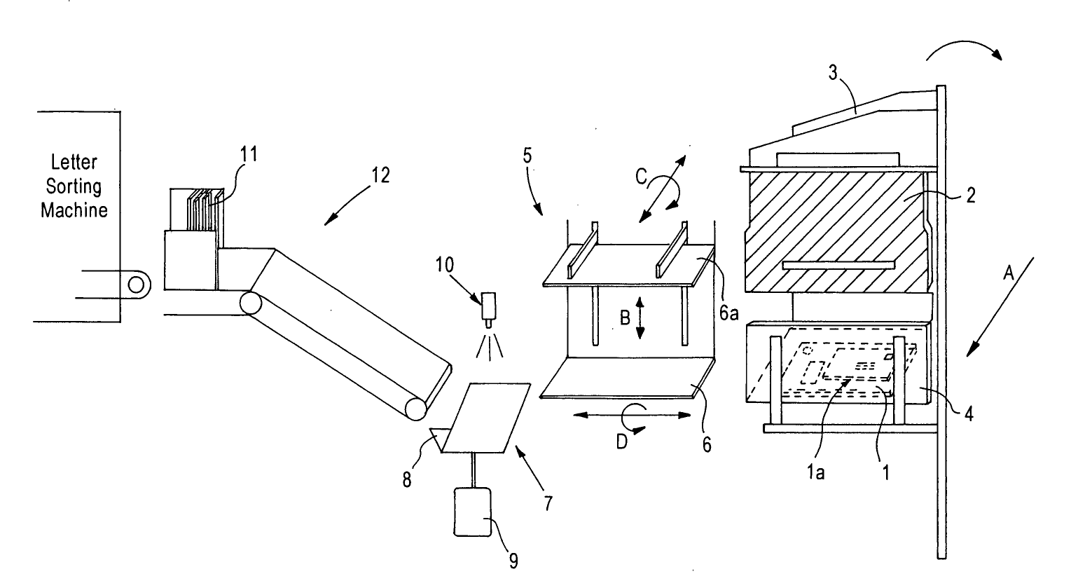

### RELATED APPLICATION

This application claims the benefit of German Application No. 10343370.8 filed Sep. 17, 2003, the disclosure of which also is entirely incorporated herein by reference.

### TECHNICAL FIELD

The present subject matter relates to a method and device for loading a machine, especially a letter sorting machine, which at the beginning comprises a conveying device for the delivery of singled incoming goods, where the incoming goods are flat goods, namely letters, which are delivered to an unloading device while heaped in a box. The box is seized by the unloading device, emptied and singled out of the processing cycle. The removed heap is levelled by the unloading device into a stack flush on two sides, and the stack is delivered to the conveying device.

### BACKGROUND

Automated methods are hitherto used in sorting of letters only with moderate success. For this reason, the loading of mail into the sorting machines is mostly carried out manually. Then, letters with different formats arrive as a disordered heap in standardised boxes. Then, the heap is taken out of the box and delivered to the sorting machine. The sorting machine sorts the individual letters, for example according to their address, or postmarks them. At the handing-in of this mail, an employee takes out the heap, levels it and puts it into the equipper of the sorting machine. The letters are then singled in the equipper, for example by means of slipping over an edge into the separate equipper of the machine. Now and again, a few chores, as for example the passing of the boxes, are partly automated with more or less success.

The disadvantage of the manual processing is, that just for the called work routine, a person has to be employed, which leads to increased financial expenditure. The work is, however, not very demanding, which easily leads to symptoms of fatigue of the personnel and thereby to mistakes in the process. The disadvantage of the known automated processes which mostly only exist as a concept is, that they only partially fulfil the requirements of processing speed and chiefly of the tolerance with respect to the varying formats of the stacks. Eventually, the known methods fail because of the complexity of the process, which can only be recognised at second glance, taking place while taking out and delivering an unsorted heap of mail of various formats.

### SUMMARY

Hence an objective is to deliver a method, which can be realised economically by simple means, by which the called work routine can be automated, especially while maintaining the orientation of the delivered flat goods at high processing speed and large tolerance with respect to the formats of the heaps. It is also an objective to create an economical and reliable working device for the realisation of the method.

This task is accomplished by a method for equipping a machine, especially for loading a letter sorting machine, which at the beginning comprises a conveying device for the delivery of singled incoming goods. The incoming goods are flat goods, namely letters, which are delivered to an unloading device while heaped in a box. The box is seized by the unloading device, emptied and singled out of the processing cycle. The removed heap is levelled by the unloading device into a stack flush on two sides. The stack is delivered to the conveying device, and the emptied stack is seized by a grab, which seizes the emptied stack by clamping it between two seizing hands and leads it towards further treatment.

A central idea lies in the grab which seizes the emptied heap by clamping it between two seizing hands and leading it towards further treatment, or rather handles it during the further treatment. Advantageously, the work routine of the grab is modelled on the manual course of handling, which would be performed by an employee in this situation. The arm of such an employee is in a way replaced by the robot arm of the grab, which simulates a natural movement.

It should be noted that under the term flat goods everything, which is transported in a relatively indiscriminate heap, like letters or circuit boards, is subsumed. A feature of the “heap” is that the edges of pieces lying on top of each other may have any orientation towards one another, while the edges of pieces in a “stack” are parallel to each other and level at least with respect to one edge. The flat goods may, however, have a rectangular form, but other geometries, for example triangles, are conceivable.

The method has several advantages. One advantage lies in the fact that the complete automation of the process at high reliability and service life is only possible with said grab. This results from the fact that the grab, due to a large number of degrees of freedom in its movement, offers the possibility of a high flexibility concerning the coping with oncoming problems. This flexibility of the grab ensures a versatile functionality of the unloading device. Complete automation, of course, contributes to a reduction of wage costs.

Another advantage lies in the fact that with the grab, which acts comparatively flexible, a buffer function in the course of the whole processing may be realised. So, the grab may react to irregularities in the delivery or in the feeder of the following sorting machine through acceleration, delay and/or modification of the motion-sequence.

The method according to this disclosure also contributes to a significant increase of the processing speed. This increase surely results, on the one hand, from the now complete and reliably working automation of the process flow. The boxes in which the flat goods are delivered are, on the other hand, relatively quickly taken out of the process by the method, which was not the case in the prior art. There, the boxes were dragged along almost through the entire process and therefore had to be handled quite ponderously. Due to the larger mass of such a box in relation to the flat goods contained therein, the handling was quite time-consuming. By removing the box swiftly, the scope for the treating of the flat good is enlarged which also leads to an increase in flexibility. With the present method, at least four to five boxes with a stock of up to 200 letters each can be processed per minute, which provides the sorting machine with a supply of up to 1000 levelled mail pieces of different dimensions per minute.

In general, an important aspect of the present method lies in the levelling of at least one edge of the flat goods before being processed further by the sorting machine. For this, the grab feeds the heap to a leveller according to the present methodology. The advantage results in that the grip of the grab may be loosened during the action of the leveller so that the flat good can be ordered relatively freely. The loosening of the grip can be adapted to the thickness of the stack so that, on the one hand, a turning over of a letter because of a too widely opened grab and, on the other hand, a clamping of the stack and thereby an insufficient levelling may be prevented. For the levelling it is advantageous to pivot the heap seized by the grab from a horizontal into a vertical position and to then insert it into the leveller, where the grip is loosened after the insertion of the heap.

The leveller can comprise two walls positioned at right angles in V-form, against which the heap is inserted with two of its sides. The levelling takes place by positioning the edges against the walls and is supported by a vibration of at least one wall. It is then especially advantageous if the edges of the letters are charged by an air stream which separates letters sticking to each other.

After the levelling, the grab seizes the heap which has been levelled into a stack again and puts it on the end of the row of the incoming goods which has to be processed by the sorting machine. Through an “intelligently” controlled grab, the possibility to feed the flat good to the leveller over again if the result of the first levelling is insufficient is given. Should the levelling still be unsuccessful after a few tries, the insufficiently levelled stack can be discarded entirely and be fed to a manual processing. Especially, a stack which is strikingly different with respect to its dimension (for example if parcels are available), its content or the quality of its levelling and so misses the predetermined conditions, may be sorted out by means of the grab. The flexibility of the method is so large that the process may be reversed entirely and the box with the flat good that may not be treated is filled again.

During the processing, the box is emptied by a stamp which drives into the box and especially settles against the heap with a sheet of metal. After that, the box is turned upside-down, where the heap comes to lie on the stamp. Even then, the box may be lifted and sorted out. In course of this starting process it is advantageous if a first levelling takes place. For this, the heap is advantageously hit against a wall of the box during the turning-over and is by that at least partially levelled within the box. This first levelling can be supported by generating a vibration which is carried forward in the box. The flat goods are then shaken against a wall of the box to level. After the emptying of the box, the heap lying on the stamp can be presented to the grab and can be seized by it. In this condition, the control of the stack is handed over to the grab.

For decoupling the function of the grab from the rest of the process and to perform the controlling with a certain kind of “intelligence”, it is advantageous to observe the movement of the grab, respectively to survey the handling of the flat goods through the grab by means of a sensor or a camera. The control of the grab can then be performed dependent upon the achieved sensor signals. In this connection it is advantageous if the work cycle of the grab is adapted to the amount in the delivery and/or the sorting capacity of the sorting machine, where the said buffer function is realised by means of the grab. The work cycle of the grab may especially be adapted to the duration of the levelling process which has to pass more or less steps according to the condition of the heap.

An unloading device which is suitable for the conversion of the above method has a posting station at which one box arrives at a time, each box being filled with a heap of letters on top of each other. The removing means of the unloading device, by which an emptying of the box is enabled, are already partially described. This unloading device may comprise a stamp, which lowers itself into the open box, settles itself against the surface of the heap and secures said heap against falling out while the box is turned upside-down. The device comprises a handling station with a grab, which seizes the heap taken from the delivered box and handles it automatically during the further processing. Also, means are assigned to the handling station for levelling the heap into a stack. By means of the grab, the stack is handed over to a distributing station. The distributing station together with the equipper forms, so to speak, the supply for the sorting machine. There, a distributing station of the known kind can be used in which the letters are put onto a belt conveyer in a row. The end of the row is held by a movable stop, which changes its position upon arrival of a new stack and sets itself against the corresponding end of the queue.

It is also advantageous that standard components, which are available on the market, may be used for building the device which realises the method. Another advantage lies in the small space requirements of such a device, which so can easily be used everywhere.

Lastly, advantages of the concepts outlined above lie in the simulation of the work which has previously been carried out manually. So, the method can be used in every place where the work cycle is still carried out by hand. There, it is especially possible to keep the orientation of the flat goods in the boxes—for example, all letters are delivered in the box with the address field on top—until the end of the procedure run. The flat good is then fed to the following sorting machine which has to be equipped as if it had been carried out manually.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWING

An exemplary device suitable for the realisation of the method is further described by reference the schematic FIGURE.

### DETAILED DESCRIPTION

The unloading device shown in the FIGURE is suitable for equipping a letter sorting machine, for example, to pre-process a heap of mail pieces and load stacked mail pieces into the sorter. The sorter comprises a feeder in the form of a conveying device for the transport of singled letters 1 at the beginning. The letters 1 are heaped into a box 2 and delivered to the unloading device at a posting station, where the delivery of the boxes is carried out along the direction of an arrow A on a not shown trolley track. The box 2 is then seized by an extracting device equipped with a swivel arm 3, which comprises a stamp that may be lowered into the open box 2. The extracting device turns the box 2 upside-down and thereby empties the heap of letters 1. After that, it lifts the box 2 and sorts it out of the process. The FIGURE shows the condition of the process at lifting the box. The letters 1 are presented to the grab 5 by a support which is limited by a wall 4.

The grab 5 comprises two seizing hands 6, which settle to the flat faces of the heap and clamp the heap with controlled contact pressure. The seizing hand 6 is for this purpose slidable along the direction of arrow B. Altogether, the grab 5 can be moved along arrows C and D and may be swivelled around these axes. The movement of the grab 5 is coordinated by an “intelligent” control, which uses the output signals of sensors and/or cameras to control the grab 5.

The grab 5 takes the heap of letters 1a out and feeds it to a leveller 7. The leveller 7 has two impact walls 8 positioned in V-form, which are set swinging by a motor 9. Via a nozzle 10, the heap laid into the leveller 7 is charged with compressed air. The stack levelled on two sides is handed over to a distributing station 12 and is there put in a row with the incoming goods 11.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A method for equipping a sorting machine, which at the beginning comprises a conveying device for the delivery of singled incoming goods, where the incoming goods are flat goods, namely letters, which are delivered while heaped in a box, the method comprising
seizing the box and emptying the letters from the box into a heap;
sorting the box out of the processing cycle;
levelling the heap into a stack flush on two sides; and
delivering the stack to the conveying device,
wherein the method includes a further step of seizing the heap emptied from the box with a grab, which seizes the emptied heap by clamping it between two seizing hands and leads it towards further treatment.

2. The method according to claim 1, wherein
the grab delivers the heap to a leveller that performs the levelling step, the grab loosens its grip during the levelling, seizes the heap levelled into a stack anew and puts the levelled stack at the end of the row of the incoming goods for the conveying device of the sorting machine.

3. The method according to claim 1, wherein:
the box is emptied by a stamp driving into the box,
said stamp settles against the heap, thereafter, the box is turned upside-down,
the heap comes to lie on the stamp, and
the box is thereinafter sorted out.

4. The method according to claim 3, wherein the heap is hit against a wall while the box is turned upside-down so the heap is at least partially levelled inside the box, by vibration of the box.

5. The method according to claim 3, wherein the heap lying on the stamp after emptying the box is presented to the grab and seized by the grab.

6. The method according to claim 2, wherein the heap is pivoted by the grab from a horizontal position into a vertical position and is then inserted into the leveller, where the grip is loosened after inserting the heap.

7. The method according to claim 1, wherein the levelling is realised by positioning edges of the flat goods against a wall and supported by vibration of the wall, where the edges of the letters are charged by air stream which separates letters sticking to each other.

8. The method according to claim 1, wherein:
the handling of the flat good through the grab is surveyed by sensors, and
a work cycle of the control of the grab is performed dependent upon the sensor signals.

9. The method according to claim 8, wherein:
the work cycle of the grab is adapted to the amount in the delivery or the sorting capacity of the sorting machine, and
the grab performs a buffer function.

10. The method according to claim 8, wherein the work cycle of the grab is adapted to the duration of the levelling process.

11. The method according to claim 1, further comprising sorting a stack which is strikingly different with respect to its dimension or the quality of its levelling and so misses a predetermined condition out by means of the grab.

12. An unloading device comprising:
a posting station, at which one box arrives at a time, each box filled with a heap of letters on top of each other, the posting station comprising removing means for emptying the box; and
a handling station, which comprises means for levelling the heap into a stack and for delivering the stack to a distributing station, where the distributing station comprises means which put the levelled stack in a row together with a previously processed stack,
wherein the handling station comprises a grab, which seizes the heap taken from the delivered box and handles it automatically during the further processing.

13. The device according to claim 12, wherein the grab comprises two seizing hands, which settle to the flat faces of the heap and clamp the heap with controlled contact pressure.

14. The device according to claim 12, wherein the means for levelling comprises a leveller positioned in a catchment area of the grab, said leveller comprising two impact walls positioned in V-form, and a motor to set the impact walls in motion.
